(19) United States
(12) Patent Application Publication
(10) Pub. No.: US 2009/0054565 A1
(43) Pub. Date: Feb. 26, 2009

(54) Flame-Retardant plastics molding composition

(75) Inventors: Frank Eisentraeger, St Pere de Ribes (ES); Sebastian Hoerold, Diedorf (DE); Wolfgang Wanzke, Augsburg (DE); Michael Hill, Koeln (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 12/229,435

(22) Filed: Aug. 22, 2008

(30) Foreign Application Priority Data
Aug. 22, 2007 (DE) 10 2007 039 560.6

(51) Int. Cl. C08K 5/3492

(52) U.S. Cl. 524/100

(57) ABSTRACT

The invention relates to a flame-retardant plastics molding composition containing from 65 to 90% by weight, based on the total amount of the molding composition, of an olefin polymer and from 10 to 35% by weight, based on the total amount of the molding composition, of a flame retardant system, containing from 40 to 80% by weight of piperazine polyphosphate which has an average chain length of from 2.2 to 1000 phosphate units (component A),
from 20 to 60% by weight of melamine cyanurate, melamine borate or condensed melamine (component B),
from 0 to 2% by weight of polytetrafluoroethylene (component C) and
from 0 to 40% by weight of ammonium polyphosphate (component D).

The present invention is described in the German priority application No. 102007039560.6, filed 22.08.2007, which is hereby incorporated by reference as is fully disclosed herein.

The invention relates to a novel flame-retardant plastics molding composition.

Polyolefins are increasingly being used in applications where flame retardancy is required. Flame retardancy is usually achieved today by the addition of bromine compounds or phosphorus compounds. Bromine compounds considerably reduce the light stability of the olefins and can therefore be used only to a very limited extent outdoors. Moreover, the addition of bromine-containing flame retardants results in increased fume density and fume toxicity.

Phosphorus-containing flame retardants require a very high dose and frequently have too low a thermal or hydrolytic stability, which has limited their usability to date. Phosphorus-containing flame retardants described are, for example, piperazine phosphates, melamine phosphates and ammonium phosphates and combinations thereof.

DE-A-0 126 454 describes flame-retardant polymeric compositions comprising from 20 to 50 parts of piperazine pyrophosphate, from 0 to 3% of titanium dioxide or silica and from 0 to 35 parts of ammonium polyphosphate, melamine, melamine phosphate or melamine pyrophosphate.

EP-A-0 650 171 describes insulation materials having high electrical resistance, consisting of a thermoplastic polymer comprising from 10 to 45% of a phosphoric acid, pyrophosphoric acid or polyphosphoric acid salt of piperazine, melamine, pyrazine, pyrimidines or hexahydropyrimidine.

EP-A-0 894 820 describes a mixture of flame retardants comprising from 45 to 65% of piperazine pyrophosphate, from 2.5 to 4% of piperazine phosphate, from 5 to 10% of melamine phosphate and from 15 to 30% of melamine. The mixture is prepared in a one-stage synthesis from phosphorus pentoxide, melamine and piperazine.

EP-A-1 277 794 describes a flame-retardant resin composition consisting of a synthetic resin, piperazine pyrophosphate, melamine pyrophosphate and an antidripping agent. The antidripping agent is polytetrafluoroethylene (PTFE) or silica or a metal oxide. The dose of the mixture of flame retardants is from 22 to 24% with 0.1% of PTFE.

EP-A-0 583 065 describes a flame-retardant composition comprising a reaction product of cyanuric acid with diamines and ammonium polyphosphate, which composition is added in amounts of from 1 to 50% to a thermoplastic resin.

Although the mixtures described develop a good or at least adequate flame retardant effect, they still have various disadvantages which to date have prevented broad industrial use in polyolefins.

Thus, the processing temperatures of the corresponding polymeric compositions have to date been limited to 200 to 250° C. by intumescent mixtures, but the preferred range for the processing of polypropylene by injection molding is, for example, from 250 to 270° C.

The water solubility of intumescent mixtures or individual components is very high in some cases, so that the flame retardant effect of the polymeric compositions treated in this manner is relatively rapidly reduced or entirely eliminated on contact with water.

In addition, particularly at high temperatures of use, a part of the flame retardant mixture may “sweat out” of the polymeric composition, which limits the usability of the polymeric composition and also reduces the flame retardant effect.

Another disadvantage in the case of all flame retardant systems known to date is the high dose required.

The aim of the present invention was therefore to provide a combination of flame retardants for thermoplastic polymers, in particular polyolefins, which are distinguished by the low dose, good thermal stability, low water solubility and little tendency to hydrolysis. Surprisingly, it was found that piperazine pyrophosphate and piperazine polyphosphates having chain lengths of 2.2-1000 in combination with nitrogen flame retardants, such as melamine cyanurate or condensed melamine (melem) and/or ammonium polyphosphates, are effective flame retardant systems which have outstanding thermal and hydrolytic stability. The combination of flame retardants may also contain antidripping agents, such as PTFE.

The flame-retardant plastics molding composition treated therewith has a high light stability, good thermal stability and aging resistance and, in the case of fire, only a low fume density and fume toxicity.

The invention therefore relates to a flame-retardant plastics molding composition containing from 65 to 90% by weight, based on the total amount of the molding composition, of an olefin polymer and from 10 to 35% by weight, based on the total amount of the molding composition, of a flame retardant system, containing from 40 to 80% by weight of piperazine polyphosphate which has an average chain length of from 2.2 to 1000 phosphate units (component A),
from 20 to 60% by weight of melamine cyanurate, melamine borate or condensed melamine (component B),
from 0 to 2% by weight of polytetrafluoroethylene (component C) and
from 0 to 40% by weight of ammonium polyphosphate (component D).

The flame retardant system preferably contains from 60 to 80% by weight of piperazine polyphosphate which has an average chain length of from 2.2 to 1000 phosphate units (component A),
from 20 to 39.9% by weight of melamine cyanurate, melamine borate or condensed melamine (component B),
from 0.1 to 2% by weight of polytetrafluoroethylene (component C) and
from 0 to 10% by weight of ammonium polyphosphate (component D).

The flame retardant system particularly preferably contains from 40 to 50% by weight of piperazine polyphosphate which has an average chain length of from 2.2 to 1000 phosphate units (component A),
from 20 to 39.9% by weight of melamine cyanurate, melamine borate or condensed melamine (component B),
from 0.1 to 2% by weight of polytetrafluoroethylene (component C) and
from 20 to 40% by weight of ammonium polyphosphate (component D).
The olefin polymer preferably comprises polyethylene, polypropylene or any desired mixtures of polymers thereof.

The piperazine polyphosphate preferably has the following chain length distribution:

| | |
|---|---|
| chain length 1 | from 0 to 10% |
| chain length 2 | from 0 to 30% |
| chain length 3 | from 0 to 30% |
| chain length 4 | from 0 to 90% |
| chain length 5 | from 0 to 25% |
| chain length 6 | from 0 to 25% |
| chain length 7 | from 0 to 40% |
| chain length 8 and longer | from 0 to 40%. |

The antidripping agent preferably comprises fluorinated polymers, in particular polytetrafluoroethylene (PTFE), and/or alkali metal or alkaline earth metal salts of perfluoroalkanesulfonic acid.

The ammonium polyphosphate (component D) is preferably coated with from 0.5 to 25%, based on its weight, of a coating composition.

The coating composition is preferably a cured melamine/formaldehyde resin or a cured epoxy resin.

The piperazine polyphosphate preferably has a median particle size (d50) of <100 μm.

The piperazine polyphosphate particularly preferably has a median particle size (d50) of <30 μm.

The piperazine polyphosphate used particularly preferably has the following chain length distribution:

| | |
|---|---|
| chain length 1 | from 0 to 5% |
| chain length 2 | from 0 to 20% |
| chain length 3 | from 0 to 20% |
| chain length 4 | from 40 to 90% |
| chain length 5 | from 0 to 15% |
| chain length 6 | from 0 to 15% |
| chain length 7 | from 0 to 30% |
| chain length 8 and longer | from 0 to 30%. |

A 10% strength suspension of the piperazine polyphosphate used in water preferably has a pH of from 1.5 to 7.

A 10% strength suspension of the piperazine polyphosphate used in water particularly preferably has a pH of from 2.0 to 5.5.

The acid number of the filtrate of a 10% strength suspension of the piperazine polyphosphate used is from 50 mg KOH/g to 600 mg KOH/g.

The acid number of the filtrate of a 10% strength suspension of the piperazine polyphosphate used is from 200 to 400 mg KOH/g.

The piperazine polyphosphate used preferably has a water solubility of not more than 7%.

The piperazine polyphosphate is characterized in that the temperature at 5% weight loss—as a measure of the thermal stability—is from 290° C. to 400° C., preferably from 300° C. to 380° C. and particularly preferably from 320° C. to 370° C.

Furthermore, the piperazine polyphosphate is characterized in that the particle size has a median particle diameter (d50) of less than 100 μm, preferably less than 50 μm and particularly preferably less than <30 μm.

Furthermore, the piperazine polyphosphate is characterized in that the residual moisture is less than 1% of the material, preferably less than 0.5% and particularly preferably less than 0.1% of the material.

The flame-retardant polymeric molding composition according to the invention contains from 65 to 90, preferably from 75 to 80, % by weight of one of the polymers mentioned below:

Polymers of mono- and diolefins, for example high, medium or low density polyethylene (which, if appropriate, may be crosslinked), polypropylene, polyisobutylene, polybut-1-ene, polymethylpent-1-ene, polyisoprene or polybutadiene and polymers of cycloolefins, such as, for example, cyclopentene or norbornene.

Mixtures of the polymers mentioned under 1), for example mixtures of polypropylene with polyethylene or with polyisobutylene.

Copolymers of mono- and diolefins with one another or with other vinyl monomers, such as, for example, ethylene-propylene copolymers, propylene-but-1-ene copolymers, propylene-isobutylene copolymers, ethylene-but-1-ene copolymers, propylene-butadiene copolymers, isobutylene-isoprene copolymers, ethylene-alkyl acrylate copolymers, ethylene-alkyl methacrylate copolymers, ethylene-vinyl acetate copolymers or ethylene-acrylic acid copolymers and salts thereof (ionomers), and terpolymers of ethylene with propylene and a diene, such as hexadiene, dicyclopentadiene or ethylidenenorbornene.

Polystyrene, poly(p-methylstyrene).

Copolymers of styrene or alpha-methylstyrene with dienes or acrylic derivatives, such as, for example, styrene-butadiene, styrene-maleic anhydride, styrene-acrylonitrile, styrene-ethyl methacrylate, styrene-butadiene-ethyl acrylate, styrene-acrylonitrile-methacrylate; mixtures of high impact strength and comprising styrene copolymers and another polymer, such as, for example, a polyacrylate, a diene polymer or an ethylene-propylene-diene terpolymer; and block copolymers of styrene, such as, for example, styrene-butadiene-styrene, styrene-isoprene-styrene, styrene-ethylene/butylene-styrene or styrene-ethylene/propylene-styrene.

Graft copolymers of styrene, such as, for example, styrene on polybutadiene, styrene and acrylonitrile on polybutadiene, styrene and maleic anhydride on polybutadiene, styrene and alkyl acrylates or alkyl methacrylates on polybutadiene, styrene and acrylonitrile on ethylene-propylene-diene terpolymers, styrene and acrylonitrile on polyalkyl acrylates or polyalkyl methacrylates, styrene and acrylonitrile on acrylate-butadiene copolymers, and mixtures thereof with the copolymers mentioned under 5), which are known, for example, as so-called ABS, MBS, ASA or AES polymers.

Preferred polymers are polyolefins, in particular polypropylene, polyethylene and ethylene-vinyl acetate copolymers.

Component A of the flame retardant system is a reaction product of piperazine and polyphosphoric acid according to equation 1:

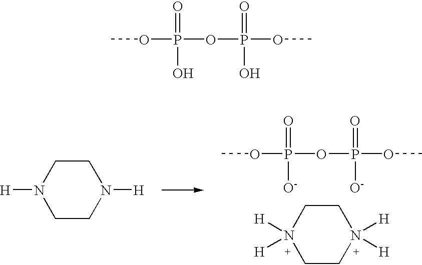

The preferred chain length is >2.2.

Component C is an antidripping agent. Component C comprises fluorinated polymers, such as polytetrafluoroethylene, polyvinylidene fluoride and polyhexafluoropropylene; alkali metal or alkaline earth metal salts of perfluoroalkanesulfonic acid, such as sodium perfluoromethanesulfonate, potassium perfluoro-n-butane-sulfonate, potassium perfluoro-t-butanesulfonate, sodium perfluorooctanesulfonate and calcium perfluoro-2-ethylhexylsulfonate. These can be used alone or in combinations.

Polytetrafluoroethylene (PTFE) is particularly preferred.

The flame retardant system according to the invention may contain, as component D, an ammonium polyphosphate of the formula (NH₄PO₃)ₙ, in which n is a number from 200 to 1000, preferably about 700, which is a free-flowing, sparing water-soluble powder and which may be coated with from 0.5 to 25% by weight of a coating composition, preferably with a cured melamine/formaldehyde resin or a cured epoxy resin.

The particle size of the flame-retardant composition used, component A, B and D, is preferably <40 μm and particularly preferably from 15 to 25 μm.

In addition to the flame retardant system, the plastics molding composition according to the invention may additionally contain the following additives:

Antioxidants, for example alkylated monophenols, alkylated hydroquinones, hydroxylated thiodiphenyl ethers, alkylidenebisphenols, benzyl compounds, acyl-aminophenols, esters of beta-(3,5-di-tert-butyl-4-hydroxyphenyl)propionic acid with mono- or polyhydric alcohols, such as, for example, with methanol, diethylene glycol, octadecanol, triethylene glycol, 1,6-hexanediol, pentaerythritol, neopentyl glycol, tris-hydroxyethyl isocyanurate, thiodiethylene glycol, dihydroxyethyloxalamide, esters of beta-(5-tert-butyl-4-hydroxy-3-methylphenyl)propionic acid with mono- or polyhydric alcohols, such as, for example, with methanol, diethylene glycol, octadecanol, triethylene glycol, 1,6-hexanediol, pentaerythritol, neopentyl glycol, trishydroxyethyl isocyanurate, thiodiethylene glycol, dihydroxyethyloxalamide, amides of beta-(3,5-di-tert-butyl-4-hydroxyphenyl)propionic acid.

UV absorbers and light stabilizers

2-(2′-Hydroxyphenyl)benzotriazoles, such as, for example, the 5′-methyl, 3′,5′-di-tert-butyl, 5′-tert-butyl, 5′-(1,1,3,3-tetramethylbutyl), 5-chloro-3′,5′-di-tert-butyl, 5-chloro-3′-tert-butyl-5′-methyl, 3′-sec-butyl-5′-tert-butyl, 4′-octyloxy, 3′,5′-di-tert-amyl and 3′,5′-bis(alpha,alpha-dimethylbenzyl) derivative.

2-Hydroxybenzophenones, for example the 4-hydroxy, 4-methoxy, 4-octoxy, 4-decyloxy, 4-dodecyloxy, 4-benzyloxy, 4,2′,4′-trihydroxy and 2′-hydroxy-4,4′-dimethoxy derivative.

Esters of optionally substituted benzoic acids, for example 4-tert-butylphenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate and hexadecyl 3,5-di-tert-butyl-4-hydroxybenzoate.

Acrylates, for example ethyl or isooctyl alpha-cyano-beta,beta-diphenyl-acrylate, methyl alpha-carbomethoxycinnamate, methyl or butyl alpha-cyano-beta-methyl-p-methoxycinnamate, methyl alpha-carbomethoxy-p-methoxycinnamate and N-(beta-carbomethoxy-9-cyanovinyl)-2-methylindoline.

Nickel compounds, for example nickel complexes of 2,2′-thiobis-[4-(1,1,3,3-tetramethylbutyl)phenol], such as the 1:1 or 1:2 complex, if appropriate with additional ligands, such as n-butylamine, triethanolamine or N-cyclohexyldiethanol-amine, alkylnickel dithiocarbamates, nickel salts of monoalkyl 4-hydroxy-3,5-di-tert-butylbenzylphosphonates, such as of the methyl or ethyl ester, nickel complexes of ketoximes, such as of 2-hydroxy-4-methylphenyl undecyl ketoxime, nickel complexes of 1-phenyl-4-lauroyl-5-hydroxypyrazole, if appropriate with additional ligands, nickel salts of 2-hydroxy-4-alkoxybenzophenones.

Sterically hindered amines, for example 2.6.1 bis(2,2,6,6-tetramethylpiperidyl)sebacate, bis(1,2,2,6,6-pentamethylpiperidyl)sebacate, bis(2,2,6,6-tetramethylpiperidyl)glutarate, bis(1,2,2,6,6-pentamethylpiperidyl)glutarate, bis(2,2,6,6-tetramethylpiperidyl)succinate, bis(1,2,2,6,6-pentamethylpiperidyl)succinate, 4-stearyloxy-2,2,6,6-tetramethylpiperidine, 4-stearyloxy-1,2,2,6,6-pentamethylpiperidine, 4-stearoyloxy-2,2,6,6-tetramethylpiperidine, 4-stearoyloxy-1,2,2,6,6-pentamethylpiperidine, 2,2,6,6-tetramethylpiperidyl behenate, 1,2,2,6,6-pentamethylpiperidyl behenate, 2,2,4,4-tetramethyl-7-oxa-3,20-diazadispiro[5.1.11.2]heneicosan-21-one, 2,2,3,4,4-pentamethyl-7-oxa-3,20-diazadispiro[5.1.11.2]heneicosan-21-one, 2,2,4,4-tetramethyl-3-acetyl-7-oxy-3,20-diazadispiro[5.1.11.2]heneicosan-21-one, 2,2,4,4-tetramethyl-7-oxa-3,20-diaza-20-(beta-lauryloxycarbonylethyl)-21-oxodispiro[5.1.11.2]heneicosane, 2,2,3,4,4-pentamethyl-7-oxa-3,20-diaza-20-(beta-lauryloxycarbonylethyl)-21-oxodispiro[5.1.11.2]heneicosane, 2,2,4,4-tetramethyl-3-acetyl-7-oxa-3,20-diaza-20-(beta-lauryloxycarbonylethyl)-21-oxodispiro[5.1.11.2]heneicosane, 1,1′,3,3′,5,5′-hexahydro-2,2′,4,4′,6,6′-hexaaza-2,2′,6,6′-bismethano-7,8-dioxo-4,4′-bis-(1,2,2,6,6-pentamethyl-4-piperidyl)biphenyl, N,N′,N″,N′″-tetrakis[2,4-bis[N-(2,2,6,6-tetramethyl-4-piperidyl)butylamino]-1,3,5-triazin-6-yl]-4,7-diazadecane-1,10-diamine, N,N′,N″,N′″-tetrakis[2,4-bis[N-(1,2,2,6,6-pentamethyl-4-piperidyl)butylamino]-1,3,5-triazin-6-yl]-4,7-diazadecane-1,10-diamine, N,N′,N″,N′″-tetrakis-[2,4-bis[N-(2,2,6,6-tetramethyl-4-piperidyl)methoxypropylamino]-1,3,5-triazin-6-yl]-4,7-diazadecane-1,10-diamine, N,N′,N″,N′″-tetrakis-[2,4-bis-[N-(1,2,2,6,6-pentamethyl-4-piperidyl)-methoxypropylamino]-1,3,5-triazin-6-yl]-4,7-diazadecane-1,10-diamine, bis(1,2,2,6,6-pentamethylpiperidyl) n-butyl-3,5-di-tert-butyl-4-hydroxybenzylmalonate, tris-(2,2,6,6-tetramethyl-4-piperidyl)nitrilotriacetate, tetrakis(2,2,6,6-tetramethyl-4-piperidyl)-1,2,3,4-butanetetracarboxylic acid, 1,1′-(1,2-ethanediyl)bis(3,3,5,5-tetramethyl-piperazinone).

Poly-N,N′-bis(2,2,6,6-tetramethyl-4-piperidyl)-1,8-diazadecylene, condensate of 1-(2-hydroxyethyl)-2,2,6,6-tetramethyl-4-hydroxypiperidine and succinic acid, condensate of N,N′-bis(2,2,6,6-tetramethyl-4-piperidyl)hexamethylenediamine and 4-tert-octylamino-2,6-dichloro-1,3,5-triazine, condensate of N,N′-bis-(2,2,6,6-tetramethyl-4-piperidyl)hexamethylenediamine and 4-morpholino-2,6-dichloro-1,3,5-triazine.

Oxalamides, for example 4,4′-dioctyloxyoxanilide, 2,2′-dioctyloxy-5,5′-di-tert-butyloxanilide, 2,2′-didodecyloxy-5,5′-di-tert-butyloxanilide, 2-ethoxy-2′-ethyloxanilide, N,N′-bis(3-dimethylaminopropyl)oxalamide, 2-ethoxy-5-tert-butyl-2′-ethyloxanilide and the mixture thereof with 2-ethoxy-2′-ethyl-5,4-di-tert-butyloxanilide, mixtures of o- and p-methoxy- and of o- and p-ethoxy-disubstituted oxanilides.

Metal deactivators, for example N,N′-diphenyloxalamide, N-salicylyl-N′-salicyloylhydrazine, N,N′-bissalicyloylhydrazine, N,N′-bis(3,5-di-tert-butyl-4-hydroxyphenylpropionyl)hydrazine, 3-salicyloylamino-1,2,3-triazole, bisbenzylideneoxalic acid dihydrazide.

Phosphites and phosphonites, for example triphenyl phosphite, diphenyl alkyl phosphites, phenyl dialkyl phosphites, trisnonylphenyl phosphite, trilauryl phosphite, trioctadecyl phosphite, distearyl pentaerythrityl diphosphite, tris(2,4-di-tert-butylphenyl)phosphite, diisodecyl pentaerythrityl diphosphite, bis(2,4-di-tert-butylphenyl)pentaerythrityl diphosphite, tristearyl sorbityl triphosphite, tetrakis(2,4-di-tert-butylphenyl)-4,4′-biphenylene diphosphonite, 3,9-bis(2,4-di-tert-butylphenoxy)-2,4,8,10-tetraoxa-3,9-diphosphaspiro[5.5]undecane, tris(2-tert-butyl-4-thio-(2′-methenyl-4′-hydroxy-5′-tert-butyl)phenyl-5-methenyl)phenyl phosphite.

Peroxide-destroying compounds, for example esters of beta-thiodipropionic acid, such as, for example, the lauryl, stearyl, myristyl or tridecyl ester, mercaptobenzimidazole, the zinc salt of 2-mercaptobenzimidazole, alkylzinc dithiocarbamates, dioctadecyl sulfide, dioctadecyl disulfide, pentaerythrityl tetrakis(beta-dodecyl-mercapto)propionate.

Basic costabilizers, for example melamine, polyvinylpyrrolidone, dicyan-diamide, triallyl cyanurate, urea derivatives, hydrazine derivative, amines, polyamines, polyurethanes, alkali metal and alkaline earth metal salts of higher fatty acids or phenolates, for example Ca stearate, Zn stearate, Mg stearate, Na ricinoleate, K palmitate, antimony pyrocatechinate or tin pyrocatechinate, hydroxides and oxides of alkaline earth metals or of aluminum, for example CaO, MgO, ZnO.

Nucleating agents, for example 4-tert-butylbenzoic acid, adipic acid, diphenylacetic acid, dibenzylidenesorbitol.

Fillers and reinforcing agents, for example calcium carbonate, silicates, glass fibers, asbestos, talc, kaolin, mica, barium sulfate, metal oxides and hydroxides, carbon black, graphite.

Other additives, for example plasticizers, lubricants, emulsifiers, pigments, optical brighteners, antistatic agents, blowing agents.

The various additional additives of the abovementioned groups 1 to 7 are added to the polymers to be stabilized in an amount of from 0.01 to 10, preferably from 0.01 to 5, % by weight, based on the total weight of the molding composition. The proportion of the additives of groups 8 and 9 is from 1 to 80, preferably from 10 to 50, % by weight, based on the total molding composition.

The additives are incorporated by generally customary methods into the organic polymers. The incorporation can be effected, for example, by mixing or applying the compounds and, if appropriate, further additives into or on the polymer immediately after the polymerization or into the melt before or during shaping. The incorporation can also be effected by application of the dissolved or dispersed compounds to the polymer directly or mixing into a solution, suspension or emulsion of the polymer, if appropriate with subsequent evaporation of the solvent. The compounds are also effective if they are introduced into an already granulated polymer subsequently in a separate processing step.

The compounds to be used according to the invention may also be added to the polymers to be provided with a flame-retardant treatment in the form of a masterbatch which contains these compounds, for example in a concentration of from 30 to 90, preferably from 50 to 80, % by weight.

The plastics molding composition according to the invention can be used in various forms, for example as films, fibers, ribbons or profiles provided with a flame-retardant treatment.

By means of the flame retardant system to be used according to the invention, both the processing temperature of the plastics molding composition is increased and the water solubility of parts of the molding composition after processing is substantially reduced. Moreover, the plastics parts provided with a flame-retardant treatment show less tendency to “sweating out” of constituents of the flame retardant system.

Components used:

| | |
|---|---|
| Polypropylene | Moplen ® HP 500N, Basell Polyolefins |
| Piperazine polyphosphate | prepared from piperazine and polyphosphoric |
| | acid, chain length >2.2 |
| Melamine cyanurate | Melapur ® MC 15, Ciba SC, Lampertheim |
| Guanidine phosphate | Degussa, Trostberg |
| Benzoguanamine | Degussa, Trostberg |
| Melem | Delacal ® M 350, Delamin Ltd., UK |
| PTFE | Dyneon ® TF 2025, Dyneon, Kelsterbach |
| Phosphite stabilizer | Sandostab ® PEP-Q, Clariant, Basle, |
| | Switzerland |

Preparation, processing and testing of flame-retardant plastics molding compositions:

The preparation of the molding composition was effected on a twin-screw extruder having corotating screws (Leistritz ZSE 27 HP 44 D type) at a temperature of 180° C., a screw speed of 250 revolutions per minute and a throughput of 20 kg per hour. Under these conditions, a melt temperature at the nozzle of about 200° C. resulted. The polymer (PP as granules) was added via the main feed and the pulverulent components A, B, C and D were added via a side metering unit. The components were processed in the ratios stated in the tables. The homogenized polymer extrudate was taken off, cooled in a water bath and then granulated.

After sufficient drying, the molding compositions were processed on an injection molding machine (Arburg 320 C Allrounder type) at a cylinder temperature setting of 180° C. at the feed to 200° C. at the die and a mold temperature of 20° C. to give test specimens and these were tested for flame retardancy and classified on the basis of the UL 94 vertical test. For the testing according to UL 94, test specimens having the dimensions 127 mm×12.7 mm×1.6 mm were produced.

The determination of the flame retardancy was carried out on the basis of the UL 94 vertical test (Underwriter Laboratories Inc., Standard for Safety, Test for Flammability of Plastic Materials for Parts in Devices and Appliances, ISBN 0-7629-0082-2). This test is used on a large scale in the area of electrical engineering and electronics applications for estimating the fire behavior and permits classification of the tested materials on action of an external ignition source in the form of an open flame. The afterburning times, the afterglowing behavior and the dripping behavior of the test specimens are evaluated. For the classification of a flame-retardant plastic in class V-0, the following criteria must be fulfilled: in a set of five test specimens, after flame application twice for a duration of 10 seconds with an open flame of defined height, no sample is permitted to continue burning for longer than 10 seconds. The sum of the afterburning times in the case of 10 flame applications to five test specimens must not be greater than 50 seconds. In addition, no dripping of flaming particles or complete burning out is permitted and the sum of afterburning and afterglowing time of the respective test specimen must not exceed 30 seconds. For classification in class V-1, it is required that the individual afterburning times be no longer than 30 seconds and that the sum of the afterburning times of 10 flame applications to five samples be no greater than 250 seconds. In addition, no dripping of flaming particles or complete burning out is permitted and the sum of afterburning and afterglowing time of the respective test specimen must not exceed 60 seconds. Classification in class V-2 takes place when, on fulfillment of the other criteria as are applicable for classification in class V-1, dripping of flaming particles occurs. If the abovementioned criteria are not fulfilled, the evaluation given is n.c.=not classifiable as V-0, V-1 or V-2. Classification in class V-0 corresponds to high flame retardancy and is set as a requirement for a number of applications in the electrical sector.

In the following examples, the afterburning time is stated in seconds.

Table 1 shows, as comparative examples, the sole use of piperazine polyphosphate, melamine cyanurate and ammonium polyphosphate in polypropylene. Classification according to UL 94 is not achieved by any of the products when used alone.

TABLE 1
Comparative examples: Flame retardant alone (data in % by
weight)

| Example | Comparison 1 | Comparison 2 | Comparison 3 |
|---|---|---|---|
| Polypropylene | 73.6 | 73.6 | 73.6 |
| Piperazine | 26 | | |
| polyphosphate | | | |
| Melamine cyanurate | | 26 | |
| Ammonium | | | 26 |
| polyphosphate | | | |
| PTFE | 0.2 | 0.2 | 0.2 |
| Phosphite stabilizer | 0.2 | 0.2 | 0.2 |
| UL-94 (1.6 mm) | n.c. | n.c. | n.c. |
| Afterburning time | >170 | >300 | >200 |
| (sec.) | | | |

Table 2 shows combinations according to the invention of piperazine polyphosphate and melamine cyanurate with PTFE. A good synergy between piperazine polyphosphate and melamine cyanurate was surprisingly found.

TABLE 2
Combination according to the invention of piperazine polyphosphate
and melamine cyanurate with PTFE (data in % by weight)

Example

| | | | | | |
|---|---|---|---|---|---|
| 1 | 2 | 3 | 4 | 5 | 6 |

| | | | | | | |
|---|---|---|---|---|---|---|
| Polypropylene | 73.6 | 73.6 | 73.6 | 73.6 | 73.6 | 73.6 |
| Piperazine | 20.8 | 19.5 | 18.5 | 17 | 16 | 15 |
| polyphosphate | | | | | | |
| Melamine | 5.2 | 6.5 | 7.5 | 9 | 10 | 11 |
| cyanurate | | | | | | |
| PTFE | 0.2 | 0.2 | 0.2 | 0.2 | 0.2 | 0.2 |
| Phosphite | 0.2 | 0.2 | 0.2 | 0.2 | 0.2 | 0.2 |
| stabilizer | | | | | | |
| UL-94 (1.6 mm) | V-0 | V-0 | V-0 | V-0 | V-0 | V-0 |
| After burning | 3 | 12 | 15 | 5 | 30 | 29 |
| time (sec.) | | | | | | |

Table 3 shows that, with a ternary combination comprising piperazine pyrophosphate, melamine cyanurate and ammonium polyphosphate, V-0 is achieved even with a small dose. The combinations of ammonium polyphosphate with piperazine pyrophosphate or melamine cyanurate on the other hand do not show sufficient flame retardancy.

TABLE 3
Comparative examples: Combination of ammonium
polyphosphate with melamine cyanurate or with piperazine polyphosphate
and combination according to the invention of piperazine polyphosphate,
melamine cyanurate and ammonium polyphosphate with PTFE (data in %
by weight)

| | Example | | | |
|---|---|---|---|---|
| | Comp. 4 | Comp. 5 | Comp. 6 | 7 |
| Polypropylene | 73.5 | 73.5 | 73.5 | 73.5 |
| Piperazine | | 17 | 13 | 8.5 |
| polyphosphate | | | | |
| Ammonium | 19.5 | 9 | 13 | 8.5 |
| polyphosphate | | | | |
| Melamine | 6.5 | | | 9 |
| cyanurate | | | | |
| PTFE | 0.3 | 0.3 | 0.3 | 0.3 |
| Phosphite | 0.2 | 0.2 | 0.2 | 0.2 |
| stabilizer | | | | |
| UL-94 (1.6 mm) | n.c. | n.c. | V-2 | V-0 |
| Afterburning time | >108 | >118 | 51 | 1 |
| (sec.) | | | | |

Table 4 shows combinations according to the invention comprising piperazine polyphosphate and melem with PTFE. Melem alone does not achieve V-0.

TABLE 4
Combination according to the invention comprising piperazine
polyphosphate and melem with PTFE (data in % by weight)

| | Example | | |
|---|---|---|---|
| | 8 | 9 | 10 |
| Polypropylene | 73.6 | 73.6 | 73.6 |
| Piperazine | 13 | 16 | 18.5 |
| polyphosphate | | | |
| Melem | 13 | 10 | 7.5 |
| PTFE | 0.2 | 0.2 | 0.2 |
| Phosphite stabilizer | 0.2 | 0.2 | 0.2 |
| UL-94 (1.6 mm) | V-1 | V-1 | V-0 |
| Afterburning time | 112 | 56 | 39 |
| (sec.) | | | |

Table 5 shows a comparison of the combination according to the invention comprising piperazine pyrophosphate with melamine cyanurate and the combination comprising piperazine pyrophosphate and melamine pyrophosphate according to EP-A-1 277 794. In the oven test at 150° C. (12 days), the combination according to the invention is surprisingly more stable.

Storage of the weighed test specimens in water was effected in a stirred bath thermostated at 23° C. After 30 days, the test specimens were first dried for 48 hours at 80° C. and then weighed again. Here too, the combination comprising piperazine pyrophosphate and melamine cyanurate shows a surprisingly smaller weight loss.

TABLE 5
(data in % by weight):

Example

| | | 12 |
|---|---|---|
| | 11 | (comparison) |
| Polypropylene | 79.6 | 73.6 |
| Piperazine polyphosphate | 10 | 10 |
| Melamine cyanurate | 10 | |
| Melamine pyrophosphate | | 10 |
| PTFE | 0.2 | 0.2 |
| Phosphite stabilizer | 0.2 | 0.2 |
| UL-94 (1.6 mm) | V-0 | V-1 |
| After burning time (sec.) | 34 | 52 |
| Oven test 150° C. (12 days) | white | brownish |
| Weight loss after storage | 0.1% | 0.5% |
| in water for 30 days | | |

1. A flame-retardant plastics molding composition comprising from 65 to 90% by weight, based on the total amount of the molding composition, of at least one olefin polymer and from 10 to 35% by weight, based on the total amount of the molding composition, of a flame retardant system, wherein the flame retardant system includes:
from 40 to 80% by weight of piperazine polyphosphate having an average chain length of from 2.2 to 1000 phosphate units (component A),
from 20 to 60% by weight of melamine cyanurate, melamine borate or condensed melamine (component B),
from 0 to 2% by weight of at least one anti-dripping agent (component C) and
from 0 to 40% by weight of ammonium polyphosphate (component D).

2. The molding composition as claimed in claim 1, wherein the flame retardant system includes:
from 60 to 80% by weight of piperazine polyphosphate having an average chain length of from 2.2 to 1000 phosphate units (component A),
from 20 to 39.9% by weight of melamine cyanurate, melamine borate or condensed melamine (component B),
from 0.1 to 2% by weight of the at least one anti-dripping agent, wherein the at least one anti-dripping agent is polytetrafluoroethylene (component C) and
from 0 to 10% by weight of ammonium polyphosphate (component D).

3. The molding composition as claimed in claim 1, wherein the flame retardant system includes:
from 40 to 50% by weight of piperazine polyphosphate having an average chain length of from 2.2 to 1000 phosphate units (component A), from 20 to 39.9% by weight of melamine cyanurate, melamine borate or condensed melamine (component B),
from 0.1 to 2% by weight of the at least one anti-dripping agent, wherein the at least one anti-dripping agent is polytetrafluoroethylene (component C) and
from 20 to 40% by weight of ammonium polyphosphate (component D).

4. The molding composition as claimed in claim 1, wherein the at least one olefin polymer comprises polyethylene, polypropylene or mixtures thereof.

5. The molding composition as claimed in claim 1, wherein the piperazine polyphosphate has the following chain length distribution:

| | |
|---|---|
| chain length 1 | from 0 to 10% |
| chain length 2 | from 0 to 30% |
| chain length 3 | from 0 to 30% |
| chain length 4 | from 0 to 90% |
| chain length 5 | from 0 to 25% |
| chain length 6 | from 0 to 25% |
| chain length 7 | from 0 to 40% |
| chain length 8 and longer | from 0 to 40%. |

6. The molding composition as claimed in claim 1, wherein the at least one antidripping agent comprises fluorinated polymers.

7. The molding composition as claimed in claim 1, wherein the ammonium polyphosphate (component D) is coated with from 0.5 to 25%, based on its weight, of a coating composition.

8. The molding composition as claimed in claim 7, wherein the coating composition is a cured melamine/formaldehyde resin or a cured epoxy resin.

9. The molding composition as claimed in claim 1, wherein the piperazine polyphosphate has a median particle size (d50) of <100 μm.

10. The molding composition as claimed in claim 1, wherein the piperazine polyphosphate has a median particle size (d50) of <30 μm.

11. The molding composition as claimed in claim 6, wherein the fluorinated polymers is selected from the group consisting of polytetrafluoroethylene (PTFE), alkali metal or alkaline earth metal salts of perfluoroalkanesulfonic acid and mixtures thereof.
